(19) United States
(12) Patent Application Publication
(10) Pub. No.: US 2026/0126752 A1
(43) Pub. Date: May 7, 2026

(54) IMAGE CARRYING MEMBER UNIT AND IMAGE FORMING APPARATUS THEREWITH

(71) Applicant: KYOCERA Document Solutions Inc., Osaka (JP)

(72) Inventor: Keiya NISHIMURA, Osaka (JP)

(73) Assignee: KYOCERA Document Solutions Inc., Osaka (JP)

(21) Appl. No.: 19/377,206

(22) Filed: Nov. 3, 2025

(30) Foreign Application Priority Data
Nov. 7, 2024 (JP) 2024-194956

(51) Int. Cl. G03G 21/00

(52) U.S. Cl. CPC G03G 21/0029; G03G 21/0017

(57) ABSTRACT

An image carrying member unit includes an image carrying member and a cleaning device. The cleaning device has a cleaning blade that makes line contact with the outer circumferential surface of the image carrying member under a predetermined pressure and that is formed of an elastic material in the shape of a rectangular parallelepiped and scraping off residual toner on the image carrying member, and a supporting member to which the cleaning blade is fixed in a state projecting upstream in the rotational direction of the image carrying member. When the free length over which the cleaning blade projects from the support member is L [mm], the thickness of the cleaning blade is t [mm], and the contact pressure of the cleaning blade against the image carrying member is W [gf/cm], then 7.5*(L/t)−23.9≤W≤24 and 12≤W.

### INCORPORATION BY REFERENCE

This application is based on and claims the benefit of priority from Japanese Patent Application No. 2024-194956 filed on Nov. 7, 2024, the contents of which are hereby incorporated by reference.

### BACKGROUND

The present disclosure relates to an electrophotographic image forming apparatuses such as copiers, printers, and facsimile machines as well as multifunction peripherals having their functions integrated together. More particularly, the present disclosure relates to an image carrying member unit including an image carrying member and a cleaning device having a cleaning blade for removing residual toner on the image carrying member, and to an image forming apparatus provided with such an image carrying member unit.

Conventional image forming apparatuses typically use powder developer and commonly employ a process is which, using a development device, an electrostatic latent image formed on an image carrying member such as a photosensitive drum is made visible with toner in the developer and the visible image (toner image) is transferred to a recording medium and is then subjected to fixing. The toner remaining on the surface of the photosensitive drum is removed by a cleaning device having a cleaning blade that is kept in pressed contact with the photosensitive drum and then a new toner image is formed.

Today, toner with a small particle size and high sphericity is used, resulting in increased adhesion of the toner to the photosensitive drum. Thus, it is necessary to increase the contact pressure of the cleaning blade to effectively remove toner remaining on the surface of the photosensitive drum. Inconveniently, increasing the contact pressure of the cleaning blade reduces the slipperiness of the surface of the photosensitive drum, particularly its slipperiness with the cleaning blade. This tends to cause squeaking (chattering) and twisting of the cleaning blade and chipping of an edge part of the cleaning blade.

Using toner with a small particle size and high sphericity also tends to cause cleaning faults due to the toner, toner external additive, or the like adhered to the surface of the photosensitive drum slipping across an edge part of the cleaning blade. When the edge part of the cleaning blade wears or chips off through repeated use, cleaning faults are likely.

### SUMMARY

According to one aspect of the present disclosure, an image carrying member unit includes an image carrying member and a cleaning device. The image carrying member is rotatable and has a toner image formed on its outer circumferential surface. The cleaning device has a cleaning blade that makes line contact with the outer circumferential surface of the image carrying member under a predetermined pressure and that is formed of an elastic material in the shape of a rectangular parallelepiped and scraping off residual toner on the image carrying member, and a supporting member to which the cleaning blade is fixed in a state projecting upstream in the rotational direction of the image carrying member. When the free length over which the cleaning blade projects from the support member is L [mm], the thickness of the cleaning blade is t [mm], and the contact pressure of the cleaning blade against the image carrying member is W [gf/cm], then Formulas (1) and (2) below are satisfied

$$7.5 * ( L / t ) - 23.9 \leq W \leq 24 \qquad ( 1 )$$

$$12 \leq W \qquad ( 2 )$$

### BRIEF DESCRIPTION OF THE DRAWINGS

FIG. 1 is a schematic sectional view showing the overall structure of an image forming apparatus including drum units according to the present disclosure.

FIG. 2 is a side sectional view showing the configuration of a drum unit according to one embodiment of the present disclosure and around a toner conveyance device coupled to it.

FIG. 3 is a perspective view of a cleaning blade and a support member used in the drum units according to the embodiment.

FIG. 4 is an enlarged perspective view around end parts of the cleaning blade and the support member in FIG. 3.

FIG. 5 is an enlarged view of a contact part between the cleaning blade and photosensitive drums in FIG. 2.

FIG. 6 is a conceptual diagram illustrating the chipping of an edge part of the cleaning blade.

FIG. 7 is a conceptual diagram showing the variation of the dynamic linear pressure of the cleaning blade observed when the photosensitive drums are driven to rotate.

FIG. 8 is a graph showing the designable region of the cleaning blade used in the drum units according to the embodiment.

FIG. 9 is a graph showing the relationship between the tolerable range of contact pressure fluctuation and the tolerance range of the cleaning blade.

FIG. 10 is a graph showing the relationship between L/t and the contact pressure W of the drum units in examples along with the results of evaluation of squeaking and twisting of the cleaning blade and chipping of the edge part and cleaning faults.

### DETAILED DESCRIPTION

### [1. Configuration of Image Forming Apparatus]

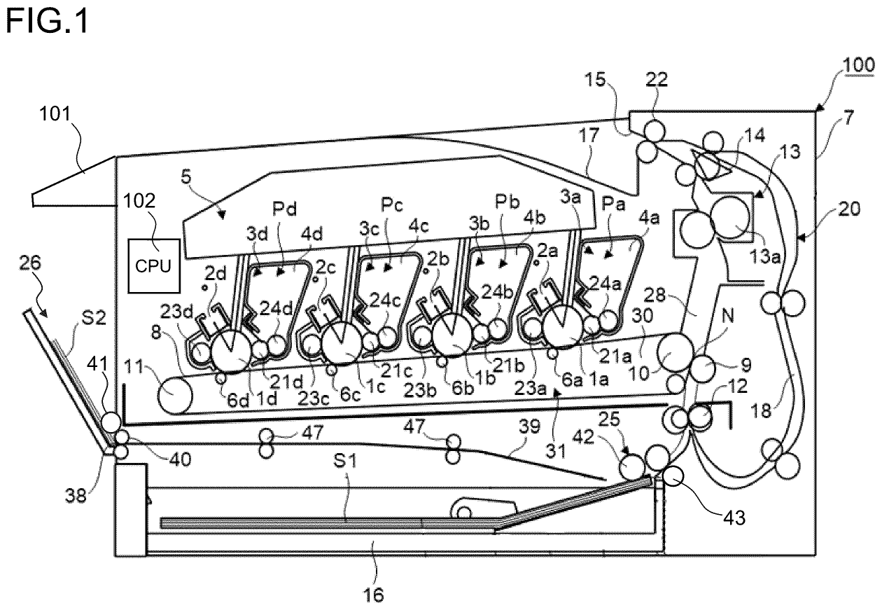

An embodiment of the present disclosure will be described below with reference to the drawings. FIG. 1 is a schematic sectional view of the internal structure of an image forming apparatus 100 including drum units 50a to 50d according to one embodiment of the present disclosure. The image forming apparatus 100 shown in FIG. 1 is what is called a tandem-type color printer.

In an apparatus main body 7 of the image forming apparatus 100, four image forming portions Pa to Pd are arranged one beside the next in the horizontal direction. The image forming portions Pa to Pd sequentially form yellow, magenta, cyan, and black images, each through the processes of electrostatic charging, exposure to light, image development, and image transfer. The image forming portions Pa to Pd are provided so as to correspond to images of the different colors. Only the image forming portion Pa will be described below and, since the image forming portions Pb to Pd have basically a similar structure, no overlapping description will be repeated.

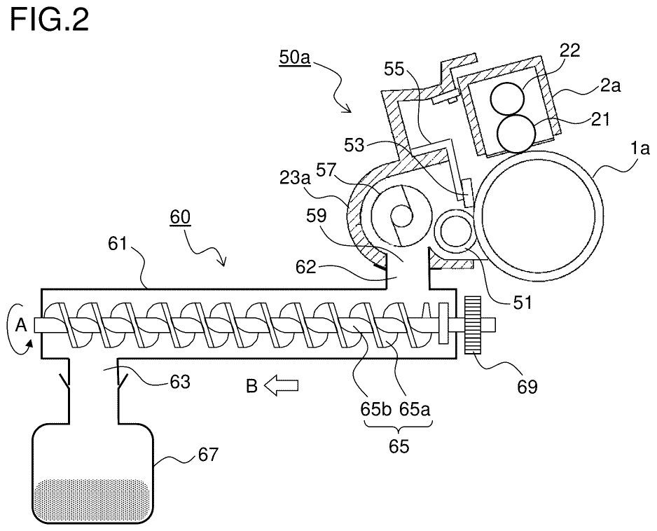

In the image forming portion Pa is arranged a photosensitive drum 1a, which carries a visible image (toner image). Above the image forming portion Pa, an exposure device 5 is arranged. The exposure device 5 irradiates the surfaces of the photosensitive drums 1a to 1d with a light beam to form on them electrostatic latent images. Around the photosensitive drum 1a, there are provided a charging device 2a, a development device 3a, and a cleaning device 23a along the drum rotation direction (clockwise in FIG. 1). In the following description, units composed of photosensitive drums 1a to 1d, charging device 2a to 2d, and cleaning devices 23a to 23d are referred to as drum units 50a to 50d (see FIG. 2) respectively.

The charging device 2a is arranged to face the photosensitive drum 1a and electrostatically charges the surface of the photosensitive drum 1a. The development device 3a has a development container 4a, a development roller 21a, and a feeding roller 24a. The development container 4a is loaded with a predetermined amount of toner. The development containers 4a to 4d are loaded with toner of yellow, magenta, cyan, and black for the development devices 3a to 3d respectively. The development roller 21a is arranged to face the photosensitive drum 1a. The feeding roller 24a feeds the toner in the development container 4a to the outer circumferential surface of the development roller 21a. The development roller 21a can feed toner fed to its outer circumferential surface to the photosensitive drum 1a.

Below the photosensitive drums 1a to 1d, an intermediate transfer unit 31 is provided. The intermediate transfer unit 31 includes a frame 30, a driving roller 10, a tension roller 11, an intermediate transfer belt 8, and primary transfer rollers 6a to 6d. The driving roller 10 and the tension roller 11 are rotatably supported at the opposite ends of the frame 30 in its longitudinal direction.

The intermediate transfer belt 8 is an endless belt (preferably a seamless belt without seams). The intermediate transfer belt 8 is wound around from the tension roller 11 to the driving roller 10 so as to be rotatable in the circumferential direction. As the driving roller 10 rotates with a rotative driving force from a belt driving motor (not shown), the rotative driving force is transmitted to the intermediate transfer belt 8 by a frictional force. Thus, the intermediate transfer belt 8 rotates in the same direction as the rotation direction of the driving roller 10. The primary transfer rollers 6a to 6d are rotatably and movably supported on the frame 30 at positions at which they face the photosensitive drums 1a to 1d across the intermediate transfer belt 8.

So as to face the driving roller 10 across the intermediate transfer belt 8, a secondary transfer roller 9 is provided. The secondary transfer roller 9 is kept in pressed contact with the intermediate transfer belt 8 to form a secondary transfer nip N. The secondary transfer roller 9 secondarily transfers the toner image formed on the intermediate transfer belt 8 to a sheet S1 or S2 passing through the secondary transfer nip N.

In the image forming apparatus 100, at positions to the side of the image forming portions Pa to Pd and the intermediate transfer belt 8, there are arranged a sheet conveyance passage 20, a pair of registration rollers 12, a sheet cassette 16, a sheet feeding portion 25, and a manual sheet feed portion 26.

The sheet conveyance passage 20 is configured to include a main conveyance passage 28 and a duplex conveyance passage 18. The main conveyance passage 28 extends in the up-down direction. Halfway along the main conveyance passage 28, the pair of registration rollers 12, the secondary transfer roller 9, and a fixing device 13 are arranged. The main conveyance passage 28 conveys the sheet S1 or S2 such that it passes from the manual sheet feed portion 26 and the sheet cassette 16, which will be described later, through the pair of registration rollers 12, the secondary transfer nip N, and the fixing device 13 in this order.

The pair of registration rollers 12 controls the conveyance direction of the sheet S1 or S2 so that the leading end (the downstream end with respect to the sheet conveyance direction) of the sheet S1 or S2 is orthogonal to the sheet conveyance direction and thereby corrects skewed conveying (a skew).

In a downstream end part of the main conveyance passage 28 with respect to the sheet conveyance direction, a sheet discharging port 15 is provided that leads to outside the image forming apparatus 100. The sheet discharging port 15 is provided with a pair of discharge rollers 22.

Between the pair of discharge rollers 22 and the fixing device 13 with respect to the sheet conveyance direction, a branch portion 14 is provided. The duplex conveyance passage 18 branches off the main conveyance passage 28 at a position where the duplex conveyance passage 18 overlaps with the branch portion 14 of the main conveyance passage 28 with respect to the sheet conveyance direction and rejoins the main conveyance passage 28 at a position upstream of the pair of registration rollers 12. The branch portion 14 can distribute the sheet S1 or S2 having passed through the fixing device 13 to the sheet discharging port 15 or to the duplex conveyance passage 18.

The sheet cassette 16 and the manual sheet feed portion 26 are provided upstream of the main conveyance passage 28 with respect to the sheet conveyance direction. The sheet cassette 16 can be stacked with sheets S1 and the manual sheet feed portion 26 can be stacked with sheets S2. The sheet feeding portion 25 is arranged between, at one end, the main conveyance passage 28 and, at the other end, the sheet cassette 16 and the manual sheet feed portion 26 and feeds the sheets S1 and S2 to the main conveyance passage 28.

The sheet cassette 16 is removably mounted in the apparatus main body 7. Specifically, the sheet cassette 16 can be pulled out of the apparatus main body 7 from a state in which the sheet cassette 16 is inserted up to the innermost part of a cassette accommodation portion 29 in the horizontal direction (mounted state).

The manual sheet feed portion 26 is attached to a side part of the apparatus main body 7, at a position between a loading port 38 and the opening edge of the cassette accommodation portion 29 with respect to the up-down direction. The manual sheet feed portion 26 can feed out sheets S2 (sheets as a recording medium, such as special-sized sheets, cardboards, envelopes, and OHP sheets) placed on its top face. The loading port 38 is provided with a pair of loading rollers 40 and a sheet feeding roller 41. As the sheet feeding roller 41 and the pair of loading rollers 40 rotate, the sheet S2 is loaded into a manual feed conveyance passage 39. The sheet S2 loaded into the manual feed conveyance passage 39 is conveyed by a pair of conveyance rollers 47 toward a pickup roller 42.

The sheet feeding portion 25 includes the pickup roller 42 and a pair of feeding rollers 43. The pickup roller 42 rotates while in contact with the top face of the sheet S1 stacked on a sheet stacking plate 37 in the sheet cassette 16 or the sheet S2 loaded from the manual sheet feed portion 26 into the manual feed conveyance passage 39. As a result, the sheet S1 or S2 is fed out in the feeding direction and delivered to the pair of feeding rollers 43.

An operation panel 101 is arranged at the front of the image forming apparatus 100. The operation panel 101 is an operation unit for accepting the input of various settings. In the image forming apparatus 100, a control portion 102 is arranged. The control portion 102 controls different units in the image forming apparatus 100 to coordinate the operation of the entire image forming apparatus 100.

Next, the image forming procedure in the image forming apparatus 100 will be described. When the user enters a command to start image formation, first, while the photosensitive drums 1a to 1d is rotated, the charging devices 2a to 2d electrostatically charge the surfaces of the photosensitive drums 1a to 1d uniformly. Next, the exposure device 5 irradiates the surfaces of the photosensitive drums 1a to 1d with light to form on them electrostatic latent images according to an image signal.

Then, the toner in the developer in the development devices 3a to 3d is fed by the development rollers 21a to 21d to the photosensitive drums 1a to 1d and electrostatically adheres to them. Thus, toner images are formed on the photosensitive drums 1a to 1d according to the electrostatic latent images.

In this state, the driving roller 10 is rotated and the intermediate transfer belt 8 is started to rotate counterclockwise. Then the toner images of different colors formed on the photosensitive drums 1a to 1d are primarily transferred sequentially to the intermediate transfer belt 8. After the completion of primary transfer, in preparation for the subsequent formation of new electrostatic latent images, the toner and the like remaining on the surfaces of the photosensitive drums 1a to 1d are removed by the cleaning devices 23a to 23d. The residual charge remaining on the photosensitive drums 1a to 1d is removed by a charge elimination device (not shown).

After that, with predetermined timing, a sheet S1 or S2 is fed out from the sheet cassette 16 or the manual sheet feed portion 26 to the main conveyance passage 28, passes through the pair of registration rollers 12, and is conveyed to the secondary transfer nip N. Then the toner images on the intermediate transfer belt 8 are secondarily transferred to the sheet S1 or S2. Next the sheet S1 or S2 is conveyed to the fixing device 13 and is heated and pressed by a pair of fixing rollers 13a in the fixing portion 13 so that the toner images are fixed to the surface of the sheet S1 or S2.

Here, when simplex printing is performed on the sheet S1 or S2, the branch portion 14 distributes the sheet S1 or S2 having passed through the fixing device 13 to the sheet discharging port 15. The sheet S1 or S2 that has reached the sheet discharging port 15 is discharged onto the discharge tray 17 by the pair of discharge rollers 22.

When duplex printing is performed on the sheet S1 or S2, the branch portion 14 distributes the sheet S1 or S2 having passed through the fixing device 13 to the duplex conveyance passage 18. The duplex conveyance passage 18, while reversing the sheet S1 or S2 top side down, conveys it again to the pair of registration rollers 12. Then the sheet S1 or S2 passes through the secondary transfer nip N and the fixing device 13 again and, after the toner images are fixed on its reverse side, the sheet S1 or S2 is distributed to the sheet discharging port 15 by the branch portion 14.

### [2. Configuration of Drum Unit and Toner Conveyance Device]

FIG. 2 is a sectional view showing a main part of the configuration of a drum unit 50a according to one embodiment of the present invention and around a toner conveyance device 60 coupled to it. The cleaning device 23a includes a rubbing roller 51 and a cleaning blade 53 that makes line contact with the photosensitive drum 1a along its longitudinal direction, and a collecting screw 57. As drum units 50b to 50d have basically a similar structure, no overlapping description will be repeated.

The rubbing roller 51 is kept in pressed contact with the photosensitive drum 1a under a predetermined pressure by a coil spring (not shown) and, by being driven by a drive means (not shown), rotates in the same direction (rotates forward) at the contact face with the photosensitive drum 1a. The peripheral speed of the rubbing roller 51 is controlled to be higher than the peripheral speed of the photosensitive drum 1a (here, 1.2 times). The rubbing roller 51 has, for example, a structure in which a foam material layer made of EPDM rubber with an Asker C hardness of 55° is formed as a roller body around a metal shaft. The material of the roller body is not limited to EPDM rubber; it may be rubber of any other material or a foam rubber material, preferably with an Asker C hardness in the range of 10 to 90°.

The cleaning blade 53 makes line contact with the photosensitive drum 1a on its surface, downstream of the contact face with the rubbing roller 51 in the rotation direction. The cleaning blade 53 is supported on a support member 55 fixed in a housing of the cleaning device 23a. Used as the cleaning blade 53 is, for example, a blade made of polyurethane rubber with a JIS hardness of 78°, and it is attached so as to form, at a contact point on the surface of the photosensitive drum 1a, a predetermined angle relative to a direction tangential to the photosensitive drum 1a. The material, hardness, dimensions, bite depth into the photosensitive drum 1a, and the like of the cleaning blade 53 are set appropriately according to the specifications of the photosensitive drum 1a.

The residual toner scraped off from the surface of the photosensitive drum 1a by the rubbing roller 51 or the cleaning blade 53 falls under gravity and gradually collects in the housing of the cleaning device 23a. Then, as the collecting screw 57 rotates, the toner in the housing is sequentially conveyed in the longitudinal direction of the housing (the direction perpendicular to the plane of FIG. 2) and is discharged through a toner discharge portion 59 provided at one end of the bottom of the housing to outside the cleaning device 23a.

The sheet feed unit 60 is configured to include a toner conveyance pipe 61 and a conveyance screw 65. At opposite ends of the toner conveyance pipe 61, a toner loading port 62 and a toner discharging port 63 are formed. The toner loading port 62 is coupled to the toner discharge portion 59 of the cleaning device 23a and the toner discharging port 63 is coupled to a waste toner bottle 37. The conveyance screw 65 is composed of a conveyance blade (spiral blade) 65a and a rotation shaft 65b that penetrates the center of the conveyance blade 65a and is rotatably supported in the toner conveyance pipe 61. One end of the rotation shaft 65b is extended to outside the toner conveyance pipe 61 and to the tip of that end a drive input gear 69 is attached. The drive input gear 69 is connected to a drive motor (not shown) and the conveyance screw 65 is driven to rotate at a predetermined speed. The toner loaded into the toner conveyance pipe 61 from the cleaning device 23a via the toner loading port 62 is sequentially conveyed through the toner transport pipe 61 in the direction indicated by arrow B by the conveyance screw 65 rotating in the direction indicated by arrow A in FIG. 2 and is stored in the waste toner bottle 37 via the toner discharge port 63.

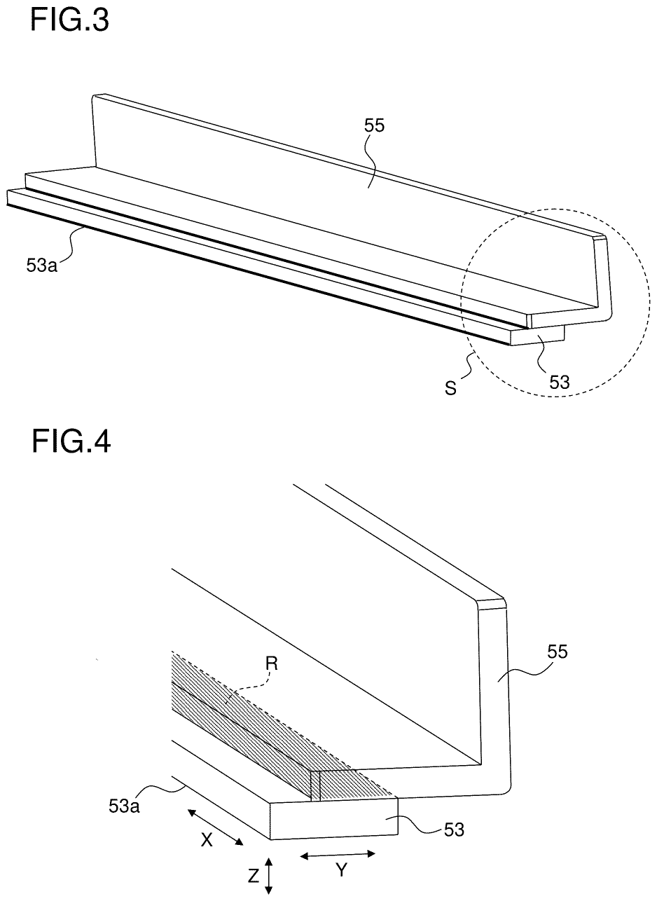

FIG. 3 is a perspective view of the cleaning blade 53 and the support member 55 used in the drum units 50a to 50d according to this embodiment. FIG. 4 is an enlarged perspective view around end parts of the cleaning blade 53 and the support member 55 (in the broken-line circle S in FIG. 3).

The support member 55 is formed by bending sheet metal such as of stainless steel into an L-shape as seen in a side view and has sufficient rigidity. The cleaning blade 53 is bonded to be fixed along outside one side (bottom side in FIG. 3) of the L-shape of the support member 55. In other words, the contact surface between the support member 55 and the cleaning blade 53 is a bonding region R (see FIG. 4).

As shown in FIG. 4, the cleaning blade 53 is bonded to be fixed so that its tip projects from the support member 55. An edge part 53a of the tip of the cleaning blade 53, on the far side from the support member 55, makes contact with the surface of the photosensitive drums 1a to 1d.

The direction (X direction in FIG. 4) along one side of the cleaning blade 53 parallel to the rotation axis of the photosensitive drums 1a to 1d is taken as the longitudinal direction of the cleaning blade 53, the direction (Y direction in FIG. 4) along another side of the cleaning blade 53 orthogonal to the longitudinal direction and extending in the movement direction of the outer circumferential surface of the photosensitive drums 1a to 1d is taken as the width direction of the cleaning blade 53, and the direction (Z direction in FIG. 4) along yet another side of the cleaning blade 53 orthogonal to the longitudinal and width directions is taken the thickness direction of the cleaning blade 53.

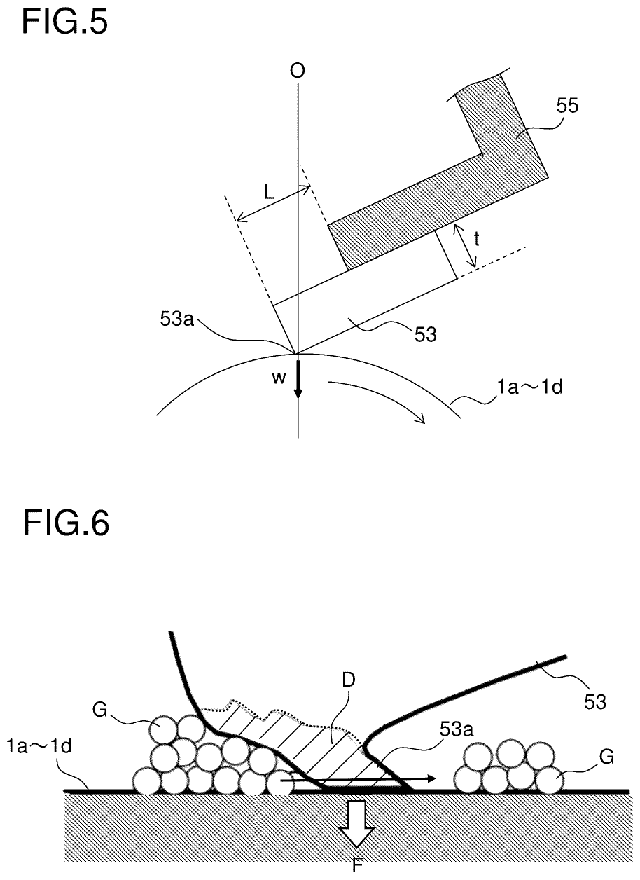

FIG. 5 is an enlarged view of a contact part between the cleaning blade 53 and the photosensitive drums 1a to 1d in FIG. 2. As shown in FIG. 5, the cleaning blade 53 has its edge part 53a in contact with the surface of the photosensitive drums 1a to 1d with its tip pointing upstream with respect to the rotation direction of the photosensitive drums 1a to 1d (clockwise in FIG. 5).

In this embodiment, when the free length of the cleaning blade 53 (the length over which it projects from the support member 55) is L [mm], its thickness is t [mm], and the contact pressure of the cleaning blade 53 against the photosensitive drums 1a to 1d is W [gf/cm], then Formulas (1) and (2) below are satisfied. Here, the contact pressure W of the cleaning blade 53 is a pressure contact force that acts toward the rotation center of the photosensitive drums 1a to 1d along a straight line O passing through the rotation center of the photosensitive drums 1a to 1d and the edge part 53a.

$$7.5 * ( L / t ) - 23.9 \leq W \leq 24 \qquad ( 1 )$$

$$12 \leq W \qquad ( 2 )$$

A design that satisfies Formulas (1) and (2) above makes it possible to prevent the chipping of the edge part 53a of the cleaning blade 53 and to prevent cleaning faults caused by toner and an external additive slipping through and the resulting image faults. How the chipping of the edge part 53a of the cleaning blade 53 is prevented in this embodiment will be described below.

FIG. 6 is a conceptual diagram illustrating the chipping of the edge part 53a of the cleaning blade 53. As shown in FIG. 6, the chipping D of the edge part 53a of the cleaning blade 53 is considered to be caused for the most part by the stress produced when an external additive agglomerates G adhering to the surface of the photosensitive drums 1a to 1d slip across the edge part 53a. That is, in order to prevent the chipping of the edge part 53a, it is necessary to suppress the slipping-through of external additive agglomerates G by reducing the amount of external additive agglomerates G that stagnates on the edge part 53a or by preventing a local drop in the dynamic linear pressure F of the cleaning blade 53.

The amount of external additive agglomerates G that stagnates on the edge part 53a varies greatly depending on the conditions under which and the system in which the image forming apparatus 1 is used. For example, in sparsely printed areas, the amount of toner left untransferred on the surfaces of the photosensitive drums 1a to 1d is small, so only a small amount of external additives is replaced at the edge part 53a and external additive agglomerates G easily form.

When the intermediate transfer belt 8 (see FIG. 1) is a resin belt, as compared with when it is an elastic belt, the external additive collection power on the surface of the photosensitive drums 1a to 1d is lower and the amount of external additive agglomerates G that stagnates on the edge part 53a tends to be larger. In addition, the amount of external additive agglomerates G varies depending on the amount and type of toner external additive added. Considering that these factors have to be taken into account to ensure the functions of the image forming operation, a method that can control a local drop in the dynamic linear pressure F of the cleaning blade 53 is considered effective.

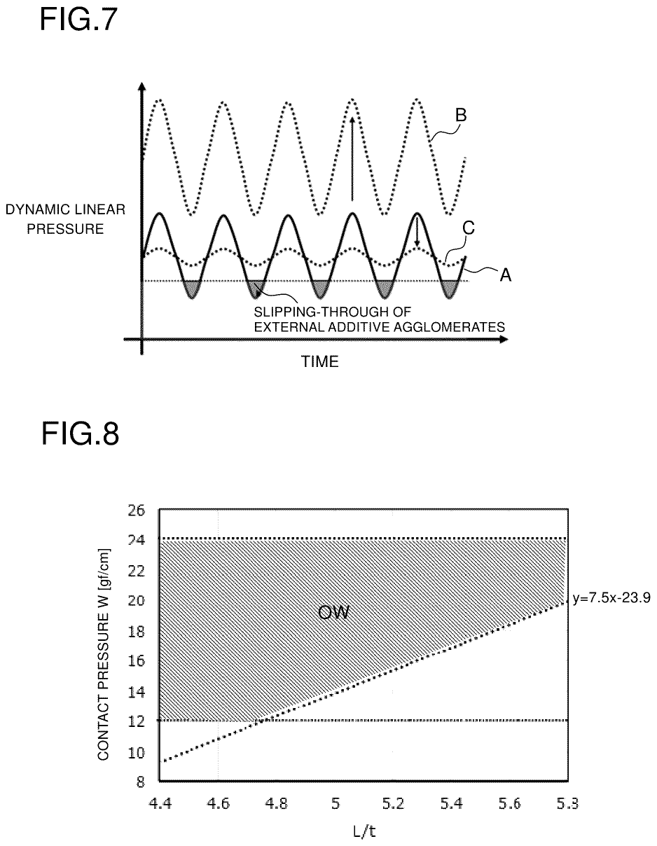

Next, how to control a local drop in the dynamic linear pressure F of the cleaning blade 53 will be described. FIG. 7 is a conceptual diagram showing the variation of the dynamic linear pressure of the cleaning blade 53 observed when the photosensitive drums 1a to 1d are driven to rotate. As indicated by solid line A in FIG. 7, the dynamic linear pressure of the cleaning blade 53 against the photosensitive drums 1a to 1d observed when the photosensitive drums 1a to 1d are driven to rotate fluctuates with a constant cycle with respect to time due to the stick-slip motion of the cleaning blade 53. During this fluctuation, when the dynamic linear pressure drops below a certain pressure, external additive agglomerates G slip through.

To keep the dynamic linear pressure from dropping below the certain pressure, it is effective to increase the contact pressure W of the cleaning blade 53 against the photosensitive drums 1a to 1d (indicated by broken line B in FIG. 7) or to reduce the amplitude of the stick-slip motion (indicated by broken line C in FIG. 7). The amplitude of the stick-slip motion is given by Formula (a) below; that is, the amplitude A [gf/cm] is proportional to the cube of the ratio (L/t) of the free length L to thickness t of the cleaning blade 53.

$$A ∝ {W ( L / t )}^{3} \qquad ( a )$$

That is, by increasing the contact pressure W or reducing L/t, it is possible to reduce the amplitude A of the stick-slip motion and keep the dynamic linear pressure can be kept above or equal to the certain pressure. As a result, it is possible to reduce the slipping-through of external additive agglomerates G at the edge part 53a and to prevent the chipping of the edge part 53a.

The relationship expressed by Formula (a) is determined only by the free length L [mm], the thickness t [mm], and the contact pressure W [gf/cm] of the cleaning blade 53, regardless of the impact resilience [%], hardness [°], and Young's modulus [MPa] of the cleaning blade 53. That is, a design that satisfies Formulas (1) and (2) prevents the chipping of the edge part 53a regardless of the material of the cleaning blade 53. Even then, the cleaning blade 53 needs to be formed of elastic material.

FIG. 8 is a graph showing a designable region of the cleaning blade 53 used in the drum units 50a to 50d according to this embodiment. As shown in FIG. 8, it has been confirmed that the smaller L/t is, the less the edge part 53a is likely to chip even in a region where the contact pressure W is low (the region above the straight line y=7.5x−23.9 in FIG. 8). By contrast, a contact pressure W higher than 24 [gf/cm] promotes the wear of the photosensitive layers of the photosensitive drums 1a to 1d and shortens the life (service life) of the drum unit 40. Also the higher frictional force with the photosensitive drums 1a to 1d causes the cleaning blade 53 to squeak or twist.

On the other hand, a contact pressure W is lower than 12 [gf/cm] causes problems such as cleaning failure and dash mark formation due to the slipping-through of the external additive. Thus, as shown in FIG. 8, it is preferable to set the blade contact pressure W of the cleaning blade 53 within the range OW (operation window, the hatched region in FIG. 8) satisfying 7.5*(L/t)−23.9≤W≤24 and 12≤W. The range of the contact pressure W mentioned above needs to be observed across the dimension tolerances of the cleaning blade 53 and throughout durable printing.

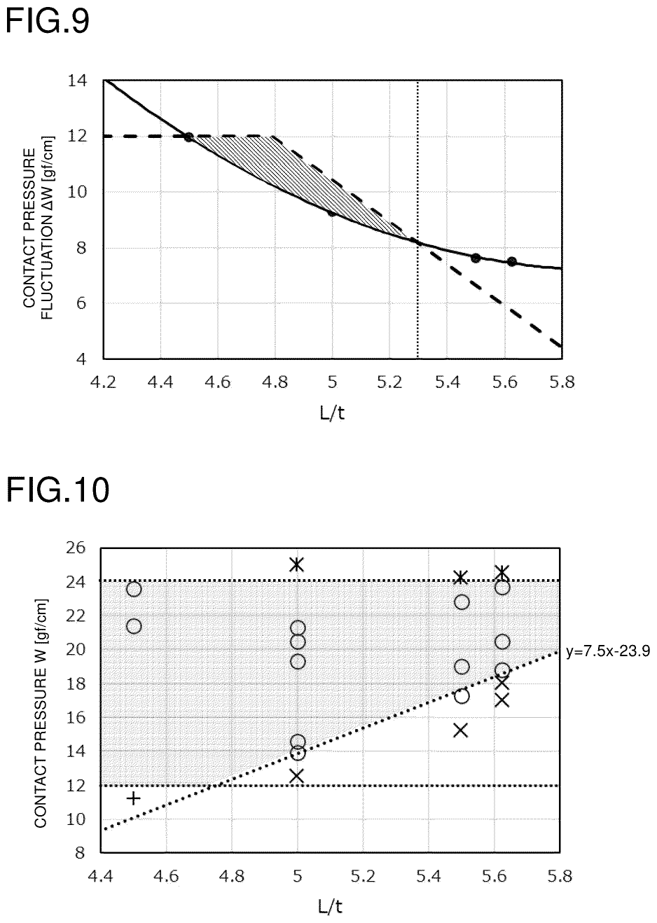

FIG. 9 is a graph showing a relationship between the tolerable range of contact pressure fluctuation and the tolerance range of the cleaning blade 53. In FIG. 9, the tolerable range of contact pressure fluctuation is indicated by a broken line and the tolerance range is indicated by a solid line. The tolerable range is calculated from OW shown in FIG. 8. More specifically, when L/t is 4.8 or less, the upper limit value of the contact pressure W is 24 [gf/cm] and its lower limit value is 12 [gf/cm], so the tolerable range of contact pressure fluctuation is 12 [gf/cm]. When L/t is 4.8 or more, the lower limit value of the contact pressure W increases along the straight line y=7.5x−23.9 and thus the tolerable range of contact pressure fluctuation becomes smaller starting at 12 [gf/cm].

The tolerable range is calculated by performing durable printing with a constant distance between the cleaning blade 53 and the photosensitive drums 1a to 1d (by a fixed displacement method), with consideration given to the dimension tolerances of the cleaning blade 53 and the amount of wear of the cleaning blade 53 during durable printing.

As shown in FIG. 9, the larger the L/t, the narrower the tolerable range of the designable contact pressure, and the smaller the L/t, the more difficult it is to design under the strong influence of tolerances. Thus, it is necessary to set the L/t within an appropriate range and it is preferable to set it, as shown in FIG. 9, within the range that satisfies Formula (3) (the hatched region in FIG. 9).

$$4.5 \leq L / t \leq 5.3 \qquad ( 3 )$$

The present disclosure is not limited to the above embodiment and can be carried out with any modifications made without departure from the spirit of the present disclosure. For example, while the above embodiment deals with cleaning devices 23a to 23d that include a rubbing roller 51 and a cleaning blade 53, the present disclosure can be applied to cleaning devices 23a to 23d that include only a cleaning blade 53.

While the embodiment described above deals with, as an example, an image forming apparatus 100 using an intermediate transfer method in which toner images formed on photosensitive drums 1a to 1d are primarily transferred to an intermediate transfer belt 8, the present disclosure is applicable equally to an image forming apparatus using a direct transfer method in which a toner image formed on a photosensitive drum is directly transferred to a recording medium. The effects of the present invention will be explained in detail below by way of examples.

### EXAMPLES

Tests were conducted to see the effect of varying the free length L, the thickness t, and the contact pressure W of the cleaning blade 53 against the photosensitive drums 1a to 1d on the prevention of squeaking and twisting of the cleaning blade 53 and chipping and cleaning faults of the edge part 53a. As a test machine, an image forming apparatus 100 (a modified version of ECOSYS PA2100; manufactured by KYOCERA Document Solutions Inc.) as shown in FIG. 1 was used, and the system line speed was set to 165 mm/sec.

As the photosensitive drums 1a to 1d, positively chargeable single-layer OPC (organic photosensitive layer) drums with a diameter of 30 mm were used, and the thickness of the photosensitive layer was 30 μm. The charging device 2a to 2d includes a charge roller made of epichlorohydrin rubber with a diameter of 9.5 mm and a thickness of 1.75 mm, and a direct-current constant voltage was applied as the charging voltage. Development devices 3a to 3d employed a two-component development method that used two-component developer containing toner and magnetic carrier. As the intermediate transfer belt 8, a resin belt was used.

The cleaning blade 53 was made of urethane rubber with a JIS-A hardness of 72°, an impact resilience of 24% at 25° C., and a Young's modulus of 7.1 MPa. The drum units 50a to 50d were produced with the thickness t of the cleaning blade 53 varied in the range of 1.6 to 2.0 mm, the free length L varied in the range of 8 to 11 mm, and the contact pressure W varied in the range of 11 to 25 [gf/cm]. Using those drum units 50a to 50d, images were output to evaluate squeaking and twisting of the cleaning blade 53 and chipping of the edge part 53a and cleaning faults.

FIG. 10 shows the relationship between L/t and the contact pressure W of the produced drum units 50a to 50d, and also the results of evaluation of squeaking and twisting of the cleaning blade 53 and chipping of the edge part 53a and cleaning faults. In FIG. 10, the horizontal axis represents L/t and the vertical axis represents the contact pressure W [gf/cm] of the cleaning blade 53, and the contact pressure W is potted versus varying L/t.

If none of squeaking and twisting of the cleaning blade 53 and chipping of the edge part 53a and cleaning faults was observed, this was indicated by a circle; if any of squeaking and twisting of the cleaning blade 53 was observed, this was indicated with an asterisk; if a half-image vertical streak due to chipping of the edge part 53a was observed, this was indicated with a cross; and if fogging due to the slipping-through of toner was observed, this was indicated with a plus sign.

As is clear from FIG. 10, in the region where the contact pressure W is equal to or higher than 24 [gf/cm], squeaking or twisting of the cleaning blade 53 occurred (asterisks in FIG. 10). In the region where the contact pressure W is equal to or lower than 7.5*(L/t)−23.9 [gf/cm], a half-image vertical streak occurred due to chipping of the edge (crosses in FIG. 10). Even if the contact pressure W was equal to or higher than 7.5*(L/t)−23.9 [gf/cm], in the region where the contact pressure W was equal to or lower than 12 [gf/cm], fogging due to the slipping-through of toner occurred (plus sign in FIG. 10).

By contrast, in the region where the contact pressure W is 12≤W and 7.5*(L/t)−23.9≤W≤24 [gf/cm] (the hatched region in FIG. 10), neither squeaking or twisting of the cleaning blade 53, nor a half-image vertical streak due to chipping of the edge part 53a, nor fogging due to the slipping-through of toner occurred.

The results above show that drum units 50a to 50d that satisfy Formulas (1) and (2) can prevent squeaking and twisting of the cleaning blade 53 and chipping of the edge part 53a and cleaning faults.

The present disclosure finds applications in image carrying member units that have integrated into a unit an image carrying member and a cleaning device including a cleaning blade for removing residual toner from the image carrying member. Based on the present disclosure, it is possible to provide an image carrying member unit that prevents chipping of an edge of the cleaning blade and eliminates cleaning faults even if the contact pressure of the cleaning blade varies due to dimension tolerances or durable printing, and to provide an image forming apparatus including such an image carrying member unit.

What is claimed is:

1. An image carrying member unit, comprising:
an image carrying member that is rotatable, the image carrying member having a toner image formed on an outer circumferential surface thereof, and
a cleaning device including:
a cleaning blade that makes line contact with the outer circumferential surface of the image carrying member under a predetermined pressure, the cleaning blade being formed of an elastic material in a shape of a rectangular parallelepiped and scraping off residual toner on the image carrying member, and
a supporting member to which the cleaning blade is fixed in a state projecting upstream in a rotational direction of the image carrying member,
wherein
when a free length over which the cleaning blade projects from the support member is L [mm], a thickness of the cleaning blade is t [mm], and a contact pressure of the cleaning blade against the image carrying member is W [gf/cm], then Formulas (1) and (2) below are satisfied.
$$7.5 * ( L / t ) - 23.9 \leq W \leq 24 \qquad ( 1 )$$
$$12 \leq W \qquad ( 2 )$$

2. The image carrying member unit, according to claim 1, wherein a ratio L/t of the free length L [mm] to the thickness t [mm] satisfies Formula (3) below.
$$4.5 \leq L / t \leq 5.3 \qquad ( 3 )$$

3. An image forming apparatus, comprising:
the image carrying member unit according to claim 1.
